(19) United States
(12) Patent Application Publication
(10) Pub. No.: US 2023/0019313 A1
(43) Pub. Date: Jan. 19, 2023

(54) LITHIUM ALLOY RESERVOIR FOR USE IN ELECTROCHEMICAL CELLS THAT CYCLE LITHIUM IONS

(71) Applicant: GM GLOBAL TECHNOLOGY OPERATIONS LLC, Detroit, MI (US)

(72) Inventors: Leng MAO, Troy, MI (US); Jeffrey David CAIN, Royal Oak, MI (US); Andrew Clay BOBEL, Troy, MI (US); Anil K. SACHDEV, Rochester Hills, MI (US); Dewen KONG, Shanghai (CN)

(73) Assignee: GM GLOBAL TECHNOLOGY OPERATIONS LLC, Detroit, MI (US)

(21) Appl. No.: 17/698,874

(22) Filed: Mar. 18, 2022

(30) Foreign Application Priority Data
Jul. 15, 2021 (CN) 202110803381.7

(51) Int. Cl. H01M 4/38; H01M 4/48; H01M 4/583; H01M 4/62; H01M 10/0525

(52) U.S. Cl. CPC H01M 4/386; H01M 4/48; H01M 4/583; H01M 4/62; H01M 10/0525; H01M 2004/027

(57) ABSTRACT

The present disclosure provides a negative electrode for an electrochemical cell that cycles lithium ions. The negative electrode may include a negative electroactive material and a lithiation additive. The negative electroactive material may have a first cell voltage window. The lithiation additive may have a second cell voltage window. The second cell voltage window may be less than the first cell voltage window. When the electrochemical cell is operated in the second cell voltage window, the lithiation additive may lithiated the cell.

### INTRODUCTION

This application claims the benefit of Chinese Patent Application No. 202110803381.7, filed Jul. 15, 2021. The entire disclosure of the above application is incorporated herein by reference.

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

In various instances, however, a portion of the intercalated lithium remains with the negative electrode following the first cycle due to, for example, conversion reactions and/or the formation of a solid electrolyte interphase (SEI) layer on the negative electrode during the first cycle, as well as ongoing lithium loss due to, for example, continuous solid electrolyte interphase breakage. Such permanent loss of lithium ions may result in a decreased specific energy and power in the battery resulting from, for example, added positive electrode mass that does not participate in the reversible operation of the battery. For example, the lithium-ion battery may experience an irreversible capacity loss of greater than or equal to about 5% to less than or equal to about 30% after the first cycle, and in the instance of silicon-containing negative electrodes, an irreversible capacity loss of greater than or equal to about 20% to less than or equal to about 40% after the first cycle. Accordingly, it would be desirable to develop improved electrodes and electroactive materials, and methods of making and using the same, that can address these challenges.

### SUMMARY

This section provides a general summary of the disclosure, and is not a comprehensive disclosure of its full scope or all of its features.

The present disclosure relates to a lithium alloy reservoir for use in an electrochemical cell that cycles lithium ions, for example, for use as a negative electroactive material in the electrochemical cell.

In various aspects, the present disclosure provides a negative electrode for an electrochemical cell that cycles lithium ions. The negative electrode may include a negative electroactive material and a lithiation additive. The negative electroactive material may have a first cell voltage window. The lithiation additive may include a lithium alloy and the lithium alloy may have a second cell voltage window. The second cell voltage window may be less than the first cell voltage window.

In one aspect, the first cell voltage window may be greater than about 2.5 V to less than or equal to about 4.2 V, and the second cell voltage window may be greater than or equal to about 1.0 V to less than about 2.5 V.

In one aspect, the negative electrode may include greater than or equal to about 30 wt. % to less than or equal to about 99.5 wt. % of the negative electroactive material, and greater than or equal to about 0.5 wt. % to less than or equal to about 20 wt. % of the lithiation additive.

In one aspect, the negative electroactive material may include silicon, silicon oxide, graphite, or any combination thereof.

In one aspect, the lithium alloy may include magnesium, aluminum, tin, gallium, calcium, zinc, barium, zirconium, indium, cerium, gold, silver, boron, germanium, lead, cadmium, silicon, or any combination thereof.

In one aspect, the lithium alloy may have an average particle size greater than or equal to about 10 nm to less than or equal to about 100 μm.

In one aspect, the lithiation additive may include a lithium-magnesium alloy.

In one aspect, the lithium-magnesium alloy may be represented by LiₓMg₁₋ₓ, where 0.1≤x≤0.95.

In various aspects, the present disclosure provides an electrochemical cell that cycles lithium ions. The electrochemical cell may include a positive electrode, a negative electrode, and a separator that physically separates the positive and negative electrodes. The negative electrode may include a negative electroactive material and a lithiation additive. The negative electrode material may have a first cell voltage window. The first cell voltage window may be greater than about 2.5 V to less than or equal to about 4.2 V. The lithiation additive may include a lithium alloy. The lithium alloy may have a second cell voltage window. The second cell voltage window may be less than the first cell voltage window. The second cell voltage window may be greater than or equal to about 1.0 V to less than about 2.5 V.

In one aspect, the negative electrode includes greater than or equal to about 30 wt. % to less than or equal to about 99.5 wt. % of the negative electroactive material, and greater than or equal to about 0.5 wt. % to less than or equal to about 20 wt. % of the lithiation additive.

In one aspect, the negative electroactive material may include silicon, graphite, or any combination thereof and the lithium alloy comprises magnesium, aluminum, tin, gallium, calcium, zinc, barium, zirconium, indium, cerium, gold, silver, boron, germanium, lead, cadmium, silicon, or any combination thereof.

In one aspect, the lithiation additive may include LiₓMg₁₋ₓ, where 0.1≤x≤0.95.

In various aspects, the present disclosure provides a method of operating an electrochemical cell that cycles lithium ions. The method may include activating a lithium reservoir in the electrochemical cell by operating the electrochemical cell in a second cell voltage window. The electrochemical cell may further include an electroactive material. The electroactive material may have a first cell voltage window. The first cell voltage window may be greater than the second cell voltage window.

In one aspect, the lithium reservoir may be activated at any point when the electrochemical cell has a capacity less than or equal to about 99% of an original capacity.

In one aspect, the method further includes deactivating the lithium reservoir by operating the electrochemical cell in the first cell voltage window when the electrochemical cell has a capacity greater than or equal to about 1% of an original capacity.

In one aspect, the first cell voltage window may be greater about 2.5 V to less than or equal to about 4.2 V, and the second cell voltage window may be greater than or equal to about 1.0 V to less than or equal to about 2.5 V.

In one aspect, the lithiation additive may include a lithium alloy. The lithium alloy may include magnesium, aluminum, tin, gallium, calcium, zinc, barium, zirconium, indium, cerium, gold, silver, boron, germanium, lead, cadmium, silicon, or any combination thereof.

In one aspect, the lithiation additive may include LiₓMg₁₋ₓ, where 0.1≤x≤0.95.

In one aspect, the negative electrode may include greater than or equal to about 30 wt. % to less than or equal to about 99.5 wt. % of the negative electroactive material, and greater than or equal to about 0.5 wt. % to less than or equal to about 20 wt. % of the lithiation additive.

In one aspect, the lithium alloy may have an average particle size greater than or equal to about 10 nm to less than or equal to about 100 μm.

Further areas of applicability will become apparent from the description provided herein. The description and specific examples in this summary are intended for purposes of illustration only and are not intended to limit the scope of the present disclosure.

### BRIEF DESCRIPTION OF THE DRAWING

The drawing described herein is for illustrative purposes only of selected embodiments and not all possible implementations, and is not intended to limit the scope of the present disclosure.

FIG. 1 is a schematic of an example electrochemical battery cell.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

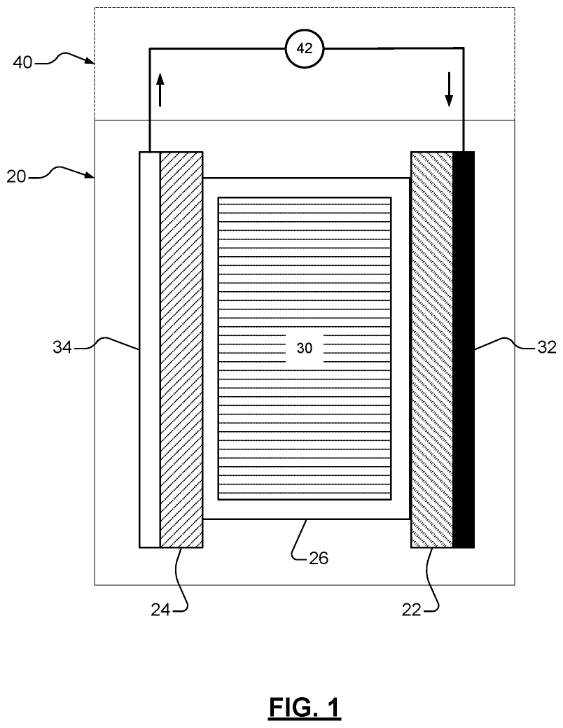

A typical lithium-ion battery (e.g., electrochemical cell that cycles lithium ions) includes a first electrode (such as, a positive electrode or cathode) opposing a second electrode (such as, a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, exemplary and schematic illustration of an electrochemical cell (also referred to as a battery) 20 is shown in FIG. 1.

Such cells are used in vehicle or automotive transportation applications (e.g., motorcycles, boats, tractors, buses, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single cathode and a single anode, the skilled artisan will recognize that the present teachings extend to various other configurations, including those having one or more cathodes and one or more anodes, as well as various current collectors with electroactive layers disposed on or adjacent to one or more surfaces thereof.

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be a solid-state electrolyte. For example, the separator 26 may be defined by a plurality of solid-state electrolyte particles (not shown).

A negative electrode current collector 32 may be positioned at or near the negative electrode 22. The negative electrode current collector 32 may be a metal foil, metal grid or screen, or expanded metal comprising copper or any other appropriate electrically conductive material known to those of skill in the art. A positive electrode current collector 34 may be positioned at or near the positive electrode 24. The positive electrode current collector 34 may be a metal foil, metal grid or screen, or expanded metal comprising aluminum or any other appropriate electrically conductive material known to those of skill in the art. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode 24. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries that include solid-state electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. In certain aspects, the electrolyte 30 may be a non-aqueous liquid electrolyte solution (e.g., >1M) that includes a lithium salt dissolved in an organic solvent or a mixture of organic solvents. In certain instances, the electrolyte 30 may also include one or more additives, such as vinylene carbonate (VC), butylene carbonate (BC), fluoroethylene carbonate (FEC), and the like. Numerous conventional non-aqueous liquid electrolyte 30 solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. The lithium salts may include one or more cations coupled with one or more anions. The cations may be selected from Li⁺, Na⁺, K⁺, Al³⁺, Mg²⁺, and the like. The anions may be selected from PF₆⁻, BF₄⁻, TFSI⁻, FSI⁻, CF₃SO₃⁻, (C₂F₅S₂O₂)N⁻, and the like. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26. The separator 26 may have a thickness greater than or equal to about 1 μm to less than or equal to about 50 μm, and in certain instances, optionally greater than or equal to about 1 μm to less than or equal to about 20 μm.

In various aspects, the porous separator 26 and the electrolyte 30 disposed in the porous separator 26 in FIG. 1 may be replaced with a solid-state electrolyte (“SSE”) (not shown) that functions as both an electrolyte and a separator. The solid-state electrolyte may be disposed between the positive electrode 24 and negative electrode 22. The solid-state electrolyte facilitates transfer of lithium ions, while mechanically separating and providing electrical insulation between the negative and positive electrodes 22, 24. By way of non-limiting example, solid-state electrolytes may include a plurality of solid-state electrolyte particles such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof. The solid-state electrolyte particles may be nanometer sized oxide-based solid-state electrolyte particles. In still other variations, the porous separator 26 and the electrolyte 30 in FIG. 1 may be replaced with a gel electrolyte.

The positive electrode 24 may be formed from a lithium-based active material that is capable of undergoing lithium intercalation and deintercalation, alloying and dealloying, or plating and stripping, while functioning as the positive terminal of the battery 20. For example, the positive electrode 24 can be defined by a plurality of electroactive material particles (not shown) disposed in one or more layers so as to define the three-dimensional structure of the positive electrode 24. The electrolyte 30 may be introduced, for example after cell assembly, and contained within pores (not shown) of the positive electrode 24. In certain variations, the positive electrode 24 may include a plurality of electrolyte particles (not shown). In each instance, the positive electrode 24 (including the one or more layers) may have a thickness greater than or equal to about 1 μm to less than or equal to about 1000 μm.

One exemplary common class of known electroactive materials that can be used to form the positive electrode 24 is layered lithium transitional metal oxides. For example, in certain aspects, the positive electrode 24 may comprise one or more materials having a spinel structure, such as lithium manganese oxide (Li₍₁₊ₓ₎Mn₂O₄, where 0.1≤x≤1), lithium manganese nickel oxide (LiMn₍₂₋ₓ₎NiₓO₄, where 0≤x≤0.5) (e.g., LiMn_{1.5}Ni_{0.5}O₄); one or more materials with a layered structure, such as lithium cobalt oxide (LiCoO₂), lithium nickel manganese cobalt oxide (Li(NiₓMn_{y}Co_{z})O₂, where 0≤x≤1, 0≤y≤1, 0≤z≤1, and x+y+z=1) (e.g., LiMn_{0.33}Ni_{0.33}Co₀.33O2), or a lithium nickel cobalt metal oxide (LiNi_{(1-x-y)}CoₓM_{y}O₂, where 0<x<0.2, y<0.2, and M may be Al, Mg, Ti, or the like); or a lithium iron polyanion oxide with olivine structure, such as lithium iron phosphate (LiFePO₄), lithium manganese-iron phosphate (LiMn₂₋ₓFeₓPO₄, where 0<x<0.5), or lithium iron fluorophosphate (Li₂FePO₄F).

In certain other aspects, the positive electrode 24 may include one or more high-voltage oxides (such as, LiNi_{0.5}Mn_{1.5}O₄, LiCoPO₄), one or more rock salt layered oxides (such as, LiCoO₂, LiNiₓMn_{y}Co_{1-x-y}O₂ (where 0<x<1, 0≤y≤1), LiNiₓCO_{y}Al_{1-x-y}O₂ (where 0≤x≤1, 0≤y≤1), LiNiₓMn₁₋ₓO₂ (where 0≤x≤1), Li₁₊ₓMO₂ (where 0≤x≤2 and where M refers to metal elements selected from Mn, Ni, Co, and the like), one or more polyanions (such as, LiV₂(PO₄)₃), and other like lithium transition metal oxides. The positive electroactive material may also be surface coated and/or doped. For example, the positive electroactive material may include LiNbO₃-coated LiNi_{0.5}Mn_{1.5}O₄.

In each instance, the positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, or lithium alginate. Electrically conducting materials may include carbon-based materials, powdered nickel or other metal particles, or a conductive polymer. Carbon-based materials may include, for example, particles of graphite, acetylene black (such as KETCHEN™ black or DENKA™ black or SuperP™), carbon fibers and nanotubes, graphene, graphene oxide, and the like. Examples of a conductive polymer include polyaniline, polythiophene, polyacetylene, polypyrrole, and the like. In certain aspects, mixtures of the conductive materials may be used.

For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive electroactive material; greater than or equal to about 0 wt. % to less than or equal to about 30 wt. %, and in certain aspects, optionally greater than or equal to about 5 wt. % to less than or equal to about 20 wt. %, of one or more electrically conductive materials; and greater than or equal to about 0 wt. % to less than or equal to about 20 wt. %, and in certain aspects, optionally greater than or equal to about 5 wt. % to less than or equal to about 15 wt. %, of one or more binders.

The negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. In certain variations, the negative electrode 22 may include a plurality of electrolyte particles (not shown). The negative electrode 22 (including the one or more layers) may have a thickness greater than or equal to about 1 μm to less than or equal to about 2000 μm, and in certain aspects, optionally greater than or equal to about 10 μm to less than or equal to about 1000 μm.

The negative electrode 22 may include a negative electroactive material that comprises lithium, such as, for example, lithium metal. In certain variations, the negative electrode may be a film or layer formed of lithium metal. Other materials can also be used to form the negative electrode 22, including, for example, carbonaceous materials (such as, graphite, hard carbon, soft carbon) and/or lithium-silicon, silicon containing binary and ternary alloys, and/or tin-containing alloys (such as, Si, Li—Si, SiOₓ (where 0≤x≤2), Si—Sn, SiSnFe, SiSnAl, SiFeCo, SnO₂, and the like). For example, in certain variations, the negative electroactive material may include a carbonaceous-silicon based composite including, for example, about 10 wt. % SiOₓ (where 0≤x≤2) and about 90 wt. % graphite.

As discussed above, during discharge, the negative electrode 22 may contain a comparatively high concentration of intercalated lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 24 by an electrochemical reduction reaction. The battery 20 may be recharged or regenerated after a partial or full discharge of its available capacity by an external power source, which reverses the electrochemical reactions that transpired during discharge.

In certain instances, however, especially in instances of silicon-containing electroactive materials, a portion of the intercalated lithium remains with the negative electrode 22 for example, conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) breakage and rebuild. The solid electrolyte interface (SEI) layer can form over the surface of the negative electrode (anode), which is often generated by reaction products of anode material, electrolyte reduction, and/or lithium ion reduction. Such permanent loss of lithium ions may result in a decreased specific energy and power in the battery 20. For example, the battery 20 may experience an irreversible capacity loss of greater than or equal to about 5% to less than or equal to about 30% after the first cycle.

Lithiation, for example pre-lithiation of the electroactive materials (e.g., silicon, carbon, graphite, and the like) prior to incorporation into the battery 20, may compensate for such lithium losses during cycling. For example, an amount of lithium prelithiation together with appropriate negative electrode capacity and/or positive electrode capacity ratio (N/P ratio) can be used to control electrochemical potential within an appropriate window so as to improve the cycle stability of the battery 20. Prelithiation can drive down the potential for silicon-containing electrodes. By way of non-limiting example, lithiation of silicon by direct reaction can be expressed by: 4.4xLi+Si→Li_{4.4x}Si, where 0≤x≤1, while for electrochemical lithiation of silicon, it can be expressed as 4.4xLi⁺+4.4xe⁻⁺Si→Li_{4.4x}Si. In each instance, the reserved lithium can compensate for lithium lost during cycling, including during the first cycle, so as to decrease capacity loss over time.

Common lithiation methods, such as electrochemical, direct contact, and lamination methods, however, often require half-cell fabrication and teardown and/or high temperature chemical processes. Furthermore, it can be difficult to control an extent of lithiation that occurs during these processes. Further, these processes often involve highly reactive chemicals and require additional manufacturing steps. These may be time consuming and potentially expensive processes. Further, such processes also commonly produce unworkable materials, for example anodes having undesirable thicknesses. The present disclosure provides an on-demand lithium alloy reservoir that can help to address these challenges.

For example, in accordance with various aspects of the present disclosure, the negative electrode 22 may further include, together with the negative electroactive material, a lithiation additive, for example, a lithium alloy or a combination of a lithium alloy and a lithium metal, configured to act as an on-demand lithium reservoir. In certain variations, a passive or resistive layer (including, for example, aluminum (Al₂O₃)) may be coated on lithium alloy particles or on particles of the lithium alloy-lithium metal composition. In certain variations, the passive or resistive layer may be a polymer-based, oxide-based, or sulfide-based lithium ion conductive material, such as poly(ethylene oxide) (PEO)-based polymer, lithium lanthanum titanate (LLTO), lithium lanthanum zirconate (LLZO), lithium aluminum titanium phosphate (LATP), lithium phosphorus sulfide (LPS), lithium phosphorus sulfur chloride iodide (LPSCl), and the like.

In each instance, the negative electrode 22 may include greater than or equal to about 0.5 wt. % to less than or equal to about 20 wt. % of the lithiation additive. The lithium reservoir can be sized by varying the lithiation additive loading. For example in certain variations, the negative electrode 22 may include about 10 wt. % of the lithiation additive and about 90 wt. % of the negative electroactive material (e.g., graphite). In various aspects, the lithium additive may be premixed with the negative electrode materials (e.g., negative electroactive materials) prior to or after slurry formation during conventional steps for making a negative electrode 22.

In certain variations, the lithium alloy may be a low-cost and air-stable lithium-magnesium composition, for example, LiₓMg₁₋ₓ (where 0.1≤x≤0.95). The lithium-magnesium alloy may have an average particle size greater than or equal to about 10 nm to less than or equal to about 100 μm, optionally greater than or equal to about 1 μm to less than or equal to about 10 μm, and in certain aspects, optionally greater than or equal to about 1 μm to less than or equal to about 5 μm. In other variations, the lithium alloy include aluminum, tin, gallium, calcium, zinc, barium, zirconium, indium, cerium, gold, silver, boron, germanium, lead, cadmium, silicon or any combination thereof. For example, the lithium alloy may be a ternary alloy, such as an aluminum-magnesium-lithium alloy (Al—Mg—Li), or other binary alloys, such as a lithium-aluminum alloy (e.g., Li₉Al₄, LiAl (50:50)), a lithium-gallium alloy (e.g., Li₂Ga), a lithium-tin alloy (e.g., Li₁₇Sn₄), a lithium-zinc alloy (LiZn), a lithium-boron alloy (LiB), a lithium-silicon alloy (e.g., Li₂₂Si₅), a lithium-lead alloy (e.g., Li₂₂Pb₅), a lithium-cadmium alloy (e.g., Li₃Cd), or a lithium-silver alloy (Li₃Ag).

In each instance, the lithiation additive provides an on-demand lithium source. For example, the lithiation additive has a lower delithiation rate and lithiation rate that the negative electroactive materials (e.g., silicon and/or graphite). As such, activation (delithiation) of the lithiation additive (i.e., lithium reservoir) can be controlled by the cell voltage window. The lithiation additive will delithiation at a consideration rate only when overpotential in the negative electrode 22 is sufficiently high (e.g., greater than or equal to about 1V to less than or equal to about 3.0 V), and as such, the cell voltage is sufficiently low (e.g., greater than or equal to about 1.0 V to less than or equal to about 2.5 V). For example, the activation voltage of the lithiation additive may be lower than the convention discharge floor for the battery 20 (e.g., about 2.5 V), but greater than the copper dissolution voltage (e.g., about 1 V).

An amount of lithium release from the lithiation additive during an activation event can be controlled by varying the duration of the low cell voltage window, as well as monitoring coulometric flow. For example, in certain variations, a constant current discharge (C/10), a constant voltage discharge, or a combination of a constant current and a constant voltage, which starts at the end of a discharge (i.e., state of charge (“SOC”)=0), may be applied until an expected amount of lithium is released from the lithium reservoir or when cell potential reaches a predetermined threshold value (e.g., about 1.0V). After the desired lithium amount is extracted from the lithiation additive, the battery 20 may continue normal recharging efforts returning the battery 20 to a top charge (e.g., about 4.2 V, or optionally, about 4.3 V) and using the battery 20 in a normal cell voltage window (e.g., greater than or equal to about 2.5 V to less than or equal to about 4.3 V, optionally greater than or equal to about 2.7 V to less than or equal to about 4.3 V, optionally greater than or equal to about 3.0 V to less than or equal to about 4.3 V, an in certain aspects, optionally greater than or equal to about 3.0 V to less than or equal to about 4.2 V)

The lithium reservoir may be activated at various points during formation and/or operation of the battery 20. For example, in certain variations, the lithium reservoir may be activated during a cell formation cycle. In other variations, the lithium reservoir may be activated periodically when the battery 20 capacity is less than a predetermined value (e.g., about 80% of the starting or original capacity). In still other variations, the lithium reservoir may be activated at or towards the end of the battery 20 life so to recover the capacity loss.

In each instance, the activation voltage of a particular lithiation additive may be controlled by varying the lithium content in the lithiation additive. For example, in certain variations, the activation voltage may decrease by greater than or equal to about 1.0 V to less than or equal to about 2.5 V when the lithium content decrease by an amount greater than or equal to about 10 wt. % to less than or equal to about 95 wt. %. Further, because of the low lithiation rate of the lithiation additive, the lithiation additive will have minimal impact on charging (e.g., less than or equal to about 10% of the lithium will re-alloy with the lithiation additive, the remaining lithium may be released as cyclable lithium), or lithiation of the negative electroactive materials. The lithiation additive may also provide a conductive path for electron transfer and enhanced electrode conductivity. For example, in certain variations, delithiation lithiation additive (e.g., LiₓMg₁₋ₓ (where 0.1≤x≤0.95)) may provide a porous structure (e.g. a metal matrix) that enhances the electrode conductivity.

In various aspects, the negative electroactive material and the lithiation additive may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black (e.g., Super-P), graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like.

For example, the negative electrode 22 may include greater than or equal to about 30 wt. % to less than or equal to about 99.5 wt. %, and in certain aspects, optionally greater than or equal to about 50 wt. % to less than or equal to about 95 wt. %, of the negative electroactive material; greater than or equal to about 0.5 wt. % to less than or equal to about 20 wt. % of the lithiation additive; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A negative electrode for an electrochemical cell that cycles lithium ions, the negative electrode comprising:
a negative electroactive material having a first cell voltage window, and
a lithiation additive comprising a lithium alloy having a second cell voltage window that is less than the first cell voltage window.

2. The negative electrode of claim 1, wherein the first cell voltage window is greater than about 2.5 V to less than or equal to about 4.2 V, and the second cell voltage window is greater than or equal to about 1.0 V to less than about 2.5 V.

3. The negative electrode of claim 1, wherein the negative electrode comprises greater than or equal to about 30 wt. % to less than or equal to about 99.5 wt. % of the negative electroactive material, and greater than or equal to about 0.5 wt. % to less than or equal to about 20 wt. % of the lithiation additive.

4. The negative electrode of claim 1, wherein the negative electroactive material comprises silicon, silicon oxide, graphite, or any combination thereof.

5. The negative electrode of claim 1, wherein the lithium alloy comprises magnesium, aluminum, tin, gallium, calcium, zinc, barium, zirconium, indium, cerium, gold, silver, boron, germanium, lead, cadmium, silicon, or any combination thereof.

6. The negative electrode of claim 5, wherein the lithium alloy has an average particle size greater than or equal to about 10 nm to less than or equal to about 100 μm.

7. The negative electrode of claim 5, wherein the lithiation additive comprises a lithium-magnesium alloy.

8. The negative electrode of claim 7, wherein the lithium-magnesium alloy is represented by LiₓMg₁₋ₓ, where 0.1≤x≤0.95.

9. An electrochemical cell that cycles lithium ions, the electrochemical cell comprising:
a positive electrode,
a negative electrode comprising:
a negative electroactive material having a first cell voltage window greater than about 2.5 V to less than or equal to about 4.2 V, and
a lithiation additive comprising a lithium alloy having a second cell voltage window greater than or equal to about 1.0 V to less than about 2.5 V; and
a separator physically separating the positive electrode and the negative electrode.

10. The electrochemical cell of claim 9, wherein the negative electrode comprises greater than or equal to about 30 wt. % to less than or equal to about 99.5 wt. % of the negative electroactive material, and greater than or equal to about 0.5 wt. % to less than or equal to about 20 wt. % of the lithiation additive.

11. The negative electrode of claim 9, wherein the negative electroactive material comprises silicon, graphite, or any combination thereof and the lithium alloy comprises magnesium, aluminum, tin, gallium, calcium, zinc, barium, zirconium, indium, cerium, gold, silver, boron, germanium, lead, cadmium, silicon, or any combination thereof.

12. The negative electrode of claim 9, wherein the lithiation additive comprises LiₓMg₁₋ₓ, where 0.1≤x≤0.95.

13. A method of operating an electrochemical cell that cycles lithium ions, the method comprising:
activating a lithium reservoir in the electrochemical cell by operating the electrochemical cell in a second cell voltage window, wherein the electrochemical cell further comprises an electroactive material having a first cell voltage window that is greater than the second cell voltage window.

14. The method of claim 13, wherein the lithium reservoir is activated at any point when the electrochemical cell has a capacity less than or equal to about 99% of an original capacity.

15. The method of claim 13, wherein the method further comprises:
deactivating the lithium reservoir by operating the electrochemical cell in the first cell voltage window when the electrochemical cell has a capacity greater than or equal to about 1% of an original capacity.

16. The method of claim 13, wherein the first cell voltage window is greater about 2.5 V to less than or equal to about 4.2 V, and the second cell voltage window is greater than or equal to about 1.0 V to less than or equal to about 2.5 V.

17. The method of claim 13, wherein the lithiation additive comprises a lithium alloy, wherein the lithium alloy comprises magnesium, aluminum, tin, gallium, calcium, zinc, barium, zirconium, indium, cerium, gold, silver, boron, germanium, lead, cadmium, silicon, or any combination thereof.

18. The method of claim 13, wherein the lithiation additive comprises LiₓMg₁₋ₓ, where 0.1≤x≤0.95.

19. The method of claim 13, wherein the negative electrode comprises greater than or equal to about 30 wt. % to less than or equal to about 99.5 wt. % of the negative electroactive material, and greater than or equal to about 0.5 wt. % to less than or equal to about 20 wt. % of the lithiation additive.

20. The method of claim 13, wherein the lithium alloy has an average particle size greater than or equal to about 10 nm to less than or equal to about 100 μm.
